(19) United States
(12) Patent Application Publication
(10) Pub. No.: US 2003/0005094 A1
(43) Pub. Date: Jan. 2, 2003

(54) TWO-MODE OPERATIONAL SCHEME FOR MANAGING SERVICE AVAILABILITY OF A NETWORK GATEWAY

(76) Inventors: RUIXI YUAN, LEXINGTON, MA (US); CLAUDIO TOPOLCIC, CONCORD, MA (US); WALTER G. HORBERT, WALTHAM, MA (US); ANDREW F. VEITCH, CARLISLE, MA (US); CARL M.E. POWELL, GAITHERSBURG, MD (US)

Correspondence Address: LEONARD C SUCHYTA, GTE SERVICE CORPORATION, 600 HIDDEN RIDGE HQEO3GI3, IRVING, TX, 75038

(21) Appl. No.: 09/408,959

(22) Filed: Sep. 30, 1999

(51) Int. Cl. G06F 15/16; G06F 15/177; G06F 15/173

(52) U.S. Cl. 709/221; 709/249; 709/223

(57) ABSTRACT

A network gateway includes at least one processor, at least one communication channel coupled to the at least one processor, and software that controls communication by the processor over the communication channel. The software has at least two modes of operation: a first mode that provides information over the at least one communication channel and a second mode that allows modification of at least a portion of said software according to data provided to the gateway. Upon powering up, the software may operate in the second mode for a predetermined amount of time. In response to receiving a first particular signal, the software may remain in the second mode to modify at least a portion of the software. The data may be provided to the gateway over the Internet.

### BACKGROUND OF THE INVENTION

1. Field of the Invention

This application relates to the field of computer networks and more particularly to the field of software that operates on a gateway of a computer network.

2. Description of Related Art

Referring to FIG. 1, a schematic illustrates operation of a conventional computer network 20. A plurality of users 22-24 receive and send data via respective ones of a plurality of Internet Service Providers (ISP) 32-34. Thus, for example, the first user 22 sends and receives data via the first ISP 32, the second user 23 sends and receives data via the second ISP 33, and the Nth user 24 sends and receives data via the Nth ISP 34. Note that, although each of the ISP's 32-34 are shown as separate units in FIG. 1, it is possible for more than one user to interface with the network 20 via the same ISP. Thus, for example, the first user 22 and the second user 23 could both interface with the network 20 via America On-line.

Each of the ISP's 32-34 is shown as being connected to the Internet, which transmits data to and from the ISP's 32-34 using any one of a plurality of conventional protocols, such as TCP/IP. It is possible in some circumstances for one of the users 22-24 to interface directly with the Internet in instances where the user 22-24 has at least some of the capabilities provided by the ISP's 32-34.

A gateway 42 for a virtual private network (VPN) is shown as being connected to the Internet. A VPN is a mechanism that allows for restricted access to resources connected to a publically-accessible network, such as the Internet. The VPN gateway 42 provides access to various private resources 44 over the Internet. Conventionally, the VPN gateway 42 may be connected directly to the Internet or may be connected to the Internet via an ISP 46.

The users 22-24 may access the private resources 44 through the Internet and via the VPN gateway 42 by establishing private communication channels called “tunnels.” The tunnels may extend from the VPN gateway 42 to the ISP's 32-34 of each of the users 22-24. Alternatively, the tunnels may extend from the VPN gateway 42 to one or more of the users 22-24. Note that, in either case, part of the data path of the tunnels includes the Internet. Thus, the VPN gateway 42 and corresponding tunnels provide the users 22-24 with remote access to the private resources 44 via the Internet. Proper establishment of the tunnels may prevent the private resources 44 from being accessed by unauthorized Internet users and may prevent unauthorized users from accessing data passed between the users 22-24 and the private resources 44. Note that, although a tunnel may be private, it may be implemented taking advantage of conventional Internet data transport technology, such as TCP/IP or UDP.

One application for such a network 20 is when the users 22-24 are members of an organization (such as a corporation) and the private resources 44 represent proprietary information of the corporation, such as internal e-mail, data files, and/or even another network. Although the users 22-24 may be geographically distant from the private resources 44, the users 22-24 may still access the private resources 44 via the Internet and the VPN gateway 42.

When the VPN gateway 42 goes down, the users 22-24 may be unable to access the resources 44 via the Internet. Such a loss of service may be due to problems with the hardware, the software, or the software configuration data of the VPN gateway 42. Thus, restoring service may require an on site visit by a technician who can repair the hardware, replace the software, and/or adjust the software configuration. However, it would be desirable to avoid the necessity of an on-site visit by a technician in order to bring an out-of-service VPN gateway back on line.

### SUMMARY OF THE INVENTION

According to the present invention, a network gateway includes at least one processor and software that controls communication by the processor, where the software has at least two modes of operation, a first mode that provides information over the Internet and a second mode that allows modification of at least a portion of the software according to data provided to the gateway. Upon powering up, the software may operate in the second mode for a predetermined amount of time. In response to receiving a first particular signal, the software may remain in the second mode to modify at least a portion of the software. The first particular signal may include a signal from a remote console indicating access thereby. The data may provided via a separate communication channel, which may be an Internet tunnel. The information may be provided by an Internet tunnel and the separate communication channel may be an other Internet tunnel, a dial up line, or a hardwired connection. The data may include configuration data or an image of at least a portion of the software.

According further to the present invention, a method of operating a network gateway includes providing data over the Internet while the gateway is in a first mode and reconfiguring the gateway in response to other data received by the gateway while the gateway is in a second mode that is different from the first mode. Upon being powered up, the gateway may enter the second mode. In response to receiving a first particular signal, the gateway may remain in the second mode. The first particular signal may include a signal from a remote console indicating access thereby. The data may be provided by an Internet tunnel. The other data may be provided via a separate communication channel. The data may be provided by an Internet tunnel and the separate communication channel may be an other Internet tunnel, a dial up line, and/or a hardwired connection. The other data may include configuration data and/or an image of a portion of the software.

According further to the present invention, a method of repairing a network gateway includes switching the gateway into a reconfiguration mode, accepting data via at least one remote communication channel while the gateway is in the reconfiguration mode, and reconfiguring the gateway according to the received data. Reconfiguring may include modifying software of the gateway and/or reconfiguration data of the gateway. The at least one remote communication channel may be an Internet tunnel.

According further to the present invention, a method for operating a network gateway includes causing the gateway to provide data over the Internet and reconfiguring the gateway according to remote data provided to the gateway in response to the gateway being at least partially non-operational. The data may be provided by an Internet tunnel.

According further to the present invention, a method for operating a network gateway includes running software to cause the gateway to provide remote data and modifying the software according to data provided to the gateway. The data may be provided by the gateway via an Internet tunnel.

The present invention allows a gateway to be reconfigured/repaired remotely, thus reducing the need for an on-site technician and thus reducing potential down time. The gateway may be placed in a known state without requiring a physical presence. In addition, software upgrades may be provided remotely so that it is not necessary to distribute software in a copyable medium (e.g., tape or floppy disk) to a plurality of sites in a manner that increases the risk of unauthorized copying.

### BRIEF DESCRIPTION OF DRAWINGS

FIG. 1 shows a conventional network that includes a VPN gateway.

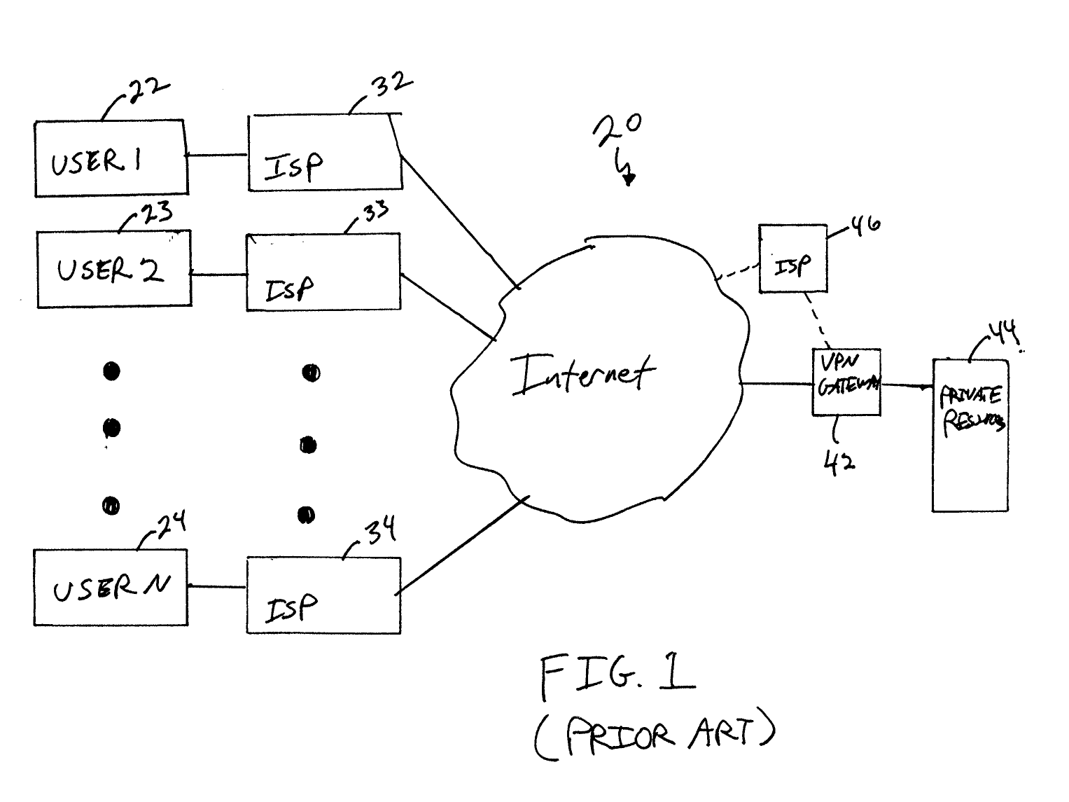

FIG. 2 is a schematic diagram illustrating a first embodiment of the present invention.

FIG. 3 is a schematic diagram illustrating a second embodiment of the present invention.

FIG. 4 is a flow chart illustrating operation of software in connection with the present invention.

### DETAILED DESCRIPTION OF THE PREFERRED EMBODIMENT(S)

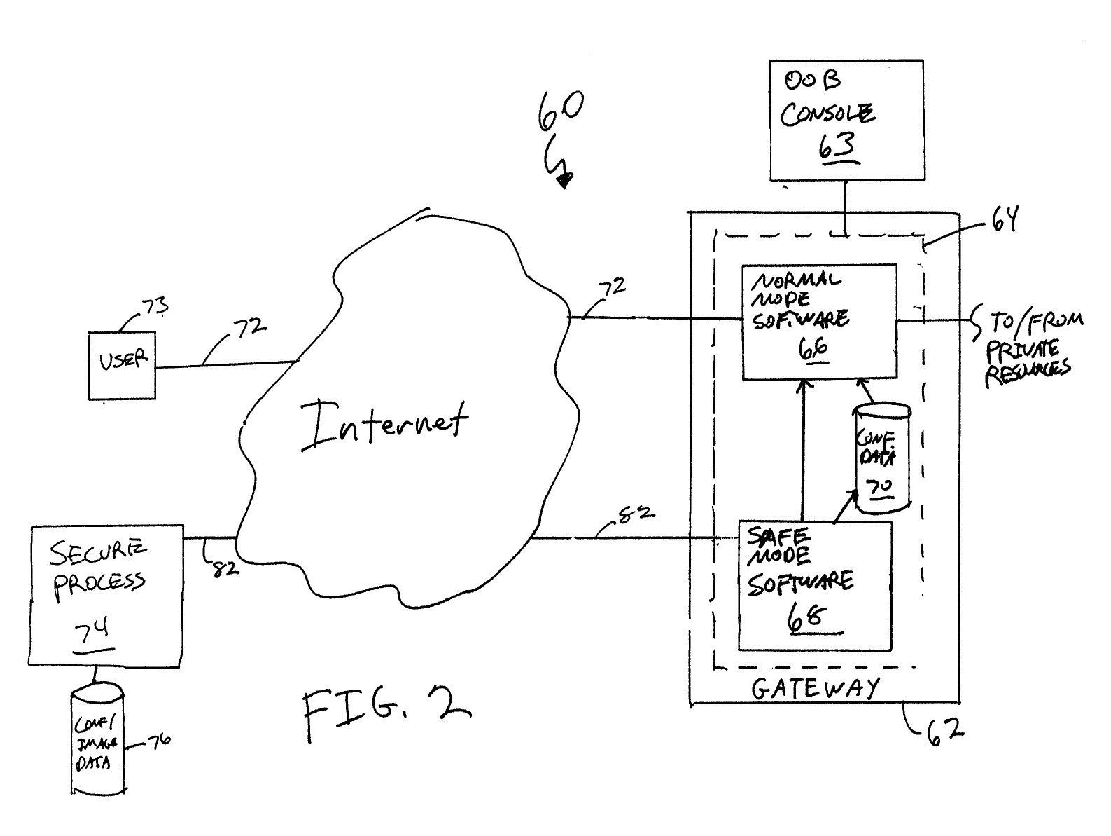

Referring to FIG. 2, a schematic diagram 60 shows in more detail operation of a gateway 62 according to the present invention. In a preferred embodiment, the gateway 62 is a VPN gateway that provides private access, via the Internet, to and from private resources. Hardware for implementing the VPN gateway 62 may include conventional gateway hardware known to one of ordinary skill in the art. The VPN gateway 62 is coupled to an Out-Of-Band (OOB) console 63 that provides access to the gateway 62 in a manner that bypasses (i.e., does not use) the Internet. The OOB console 63 is discussed in more detail below.

The VPN gateway 62 includes software 64 that is executed by a processor of the gateway 62. (In other embodiments, the VPN gateway 62 may be implemented by a plurality of processors.) The software 64 includes two sub-components: normal mode software 66 and safe mode software 68. The normal mode software 66 provides conventional access to and from the private resources via the Internet. A configuration data element 70 provides configuration data used by the normal mode software 66 to establish operational configuration parameters for the normal mode software 66. The safe mode software 68 may include other configuration data (not shown) that is used exclusively by the safe mode software 68 and is separate from the configuration data 70.

The software 64 for the gateway 62 also includes a component corresponding to the safe mode software 68. The safe mode software 68 provides special access to the VPN gateway 62 and to the software 64 in order to allow for certain failure conditions to be repaired remotely rather than relying on an on site technician. In a preferred embodiment, the safe mode software 68 is thoroughly tested, robust, and not updated as frequently as the normal mode software 66. As discussed in detail below, the safe mode software 68 allows modification/replacement of the image for the normal mode software 66 and, in addition, the safe mode software 68 may be used to modify the configuration data 70. Thus, when the gateway 62 goes down, the safe mode software 68 may be used to modify/replace the image of the normal mode software 66 and/or modify/replace the configuration data 70. In addition, the safe mode software 68 may used for upgrades to the normal mode software 66 and/or to the configuration data 70.

When the gateway 62 is in normal operating mode (i.e., there is no failure), then data to and from the private resources coupled to the gateway 62 is provided to and from the Internet via an Internet tunnel 72 that may be established in a conventional manner. A remote user 73 having appropriate access can send and receive data to and from the private resources by accessing the gateway 62 via the Internet through the tunnel 72. Internet users without appropriate access may not access the private resources or access data passed through the tunnel 72.

The gateway 62 could fail because of a failure in the gateway software 66 and/or a mistake in one of the configuration parameters stored in the configuration data 70. In that case, the gateway 62 can be made to enter into a safe mode in which the safe mode software 68 is executed. While the gateway 62 is in the safe mode, the normal mode software 66 and/or the configuration data 70 may be modified remotely over the Internet via a secure process 74, such as a Telnet console. As set forth above, the safe mode software 68 may include other configuration data (not shown) that is used exclusively by the safe mode software 68 and is separate from the configuration data 70. In a preferred embodiment, the secure process 74 may upload a new image for the normal mode software 66 to the gateway 62 via a second tunnel 82 between the process 74 and the gateway 62. The secure process 74 could also update/adjust the configuration data 70 over the Internet using the same mechanism. The safe mode software 68 provides remote access to the normal mode software 66 and the configuration data 70 via the tunnel 82 and the secure process 74. Thus, in instances where the gateway 62 fails due to a software and/or configuration failure, the gateway 62 may be made operational by a remote user accessing the gateway 62 over the Internet via the secure process 74. Note that, although the tunnels 72,82 are separate logical channels, the tunnels 72,82 may share portions of the same physical channel and/or communications hardware, such as using the same input cable and/or input port to the gateway 62.

A new image for the normal mode software 66, as well as new data for the configuration data element 70, may be stored in a data file 76 that is accessible by the secure process 74. In a preferred embodiment, access by the secure process 74 may require the remote user to enter an appropriate password and user identification.

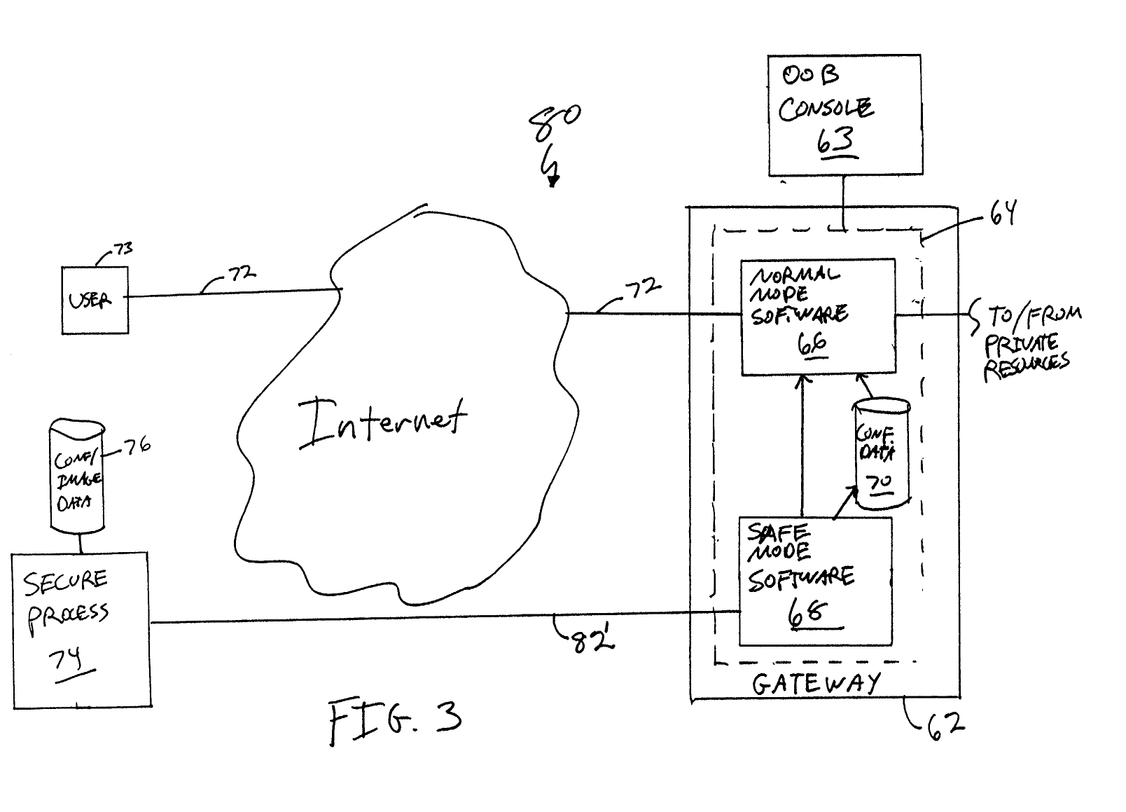

Referring to FIG. 3, a schematic diagram 80 illustrates an alternative embodiment of the present invention in which the Internet is not used by the secure process 74. In the embodiment of FIG. 3, the secure process 74 accesses the safe mode software 68 using another link 82′. The other link 82′ could be a dial-up connection, a hardwired connection, or any other appropriate connection apparent to one of ordinary skill in the art.

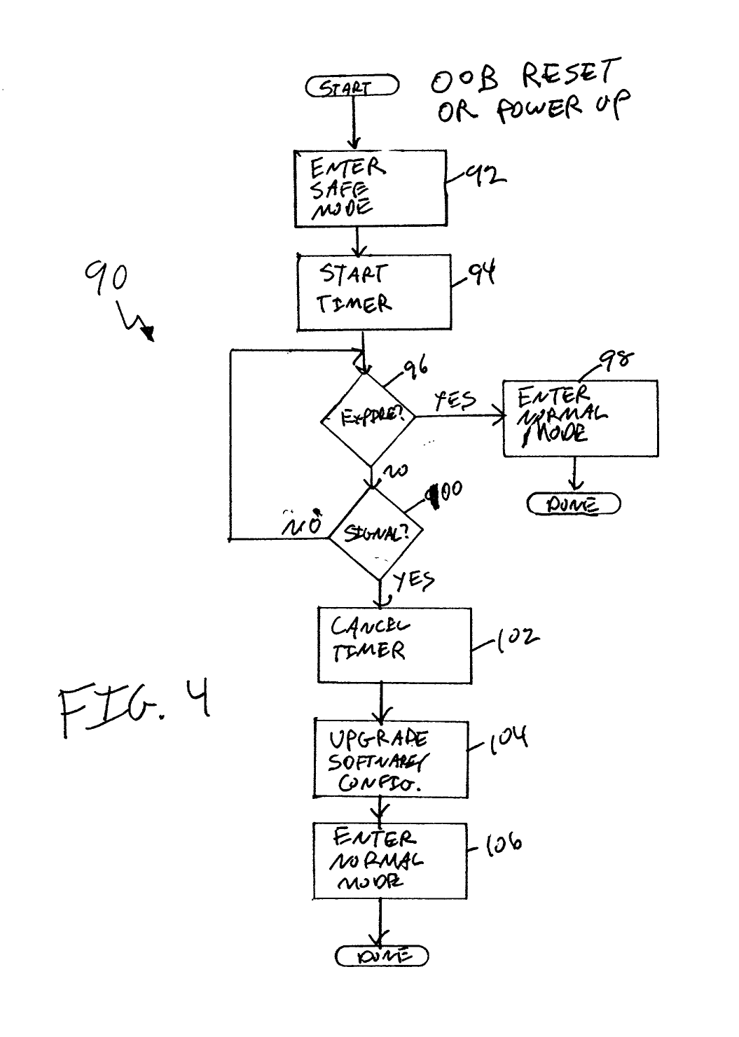

Referring to FIG. 4, a flow chart 90 illustrates operation of the safe mode software 66 for the gateway 62. The flow begins either when the gateway 62 is physically powered up or upon a reset command provided at the OOB console 63. Having a reset command provided at the OOB console 63 cause the gateway 62 to enter the safe mode may be disabled in certain circumstances. In particular, the remote process 74 may set the degree of access provided to the OOB console 63. The remote process 74 may disable the OOB console 63 entirely, may allow only the reset command to be entered at the OOB console 63, or may provide additional functionality to the OOB console 63. In a preferred embodiment, entering a reset at the OOB console 63 may require additional entry of a user authentication name and a password.

At a first step 92 of the flowchart 90, the gateway 62 enters the safe mode and begins by executing the safe mode software 68. That is, the gateway 62 first enters the safe mode upon power up or, as discussed above, when a reset command is provided at the OOB console 63. Following the first step 92 is a step 94 where a timer is started. As described in more detail below, a timer is used to exit the safe mode.

Following the step 94 is a test step 96 where it is determined if the timer has expired. The timer may be set at the step 94 to, for example, five minutes. If it is determined at the step 96 that the timer has expired, then the control passes from the test step 96 to a step 98 where the gateway 62 is made to enter the normal mode and execute the normal mode software 66.

If it is determined at the step 96 that the timer has not expired, then control passes from the test step 96 to a test step 100 where it is determined if a signal has been received indicating access by the secure process 74. If not, then control passes back to the test step 96 to determine if the timer has expired. Otherwise, if it is determined at the test step 100 that a signal has been received from the secure process 74, then control passes from the test step 100 to a step 102 where the time out is canceled (e.g., the timer stops counting). Thus, upon power-up, the gateway 62 enters into the safe mode and, if a signal is not received from the secure process 74 after a predetermined amount of time, enters the normal mode. Otherwise, if the gateway 62 does receive a signal from the secure process 74, then the gateway 62 remains in a safe mode so that the software and/or configuration may be updated.

Following the step 102 is a step 104 where the configuration data 70 is upgraded and/or the normal mode software 66 is repaired by, for example, replacing the image. In either case, the data may be transferred in any one of a variety of conventional fashions familiar to one of ordinary skill in the art. Following the step 104, control passes to a step 106 where the normal mode is entered upon entry of an explicit command or after the time out period, as described above. Assuming the fix that occurred at the step 104 is effective, then the gate 62 should operate properly in the normal mode at the step 106. Following the step 106, processing is complete. Note that the mechanism discussed herein may be used to upgrade the normal mode software 68 and/or configuration data 70 and may also be used when the gateway 62 becomes non-operational due to a failure caused by the normal mode software 68 and/or the configuration data 70.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

1. A network gateway, comprising:
at least one processor; and
software that controls communication by the processor, said software having at least two modes of operation, a first mode that provides information over the Internet and a second mode that allows modification of at least a portion of said software according to data provided to the gateway.

2. A network gateway, according to claim 1, wherein, upon powering up, said software operates in said second mode for a predetermined amount of time.

3. A network gateway, according to claim 2, wherein, in response to receiving a first particular signal, said software remains in said second mode to modify at least a portion of said software.

4. A network gateway, according to claim 3, wherein said first particular signal includes a signal from a remote console indicating access thereby.

5. A network gateway, according to claim 1, wherein the data is provided via a separate communication channel.

6. A network gateway, according to claim 5, wherein the separate communication channel is an Internet tunnel.

7. A network gateway, according to claim 5, wherein the information is provided by a first Internet tunnel and the separate communication channel is one of: a second Internet tunnel, a dial up line, and a hardwired connection.

8. A network gateway, according to claim 1, wherein the data includes at least one of: configuration data and an image of at least a portion of the software.

9. A network gateway, comprising:
at least one processor;
first control means, for causing said processor to provide information over the Internet; and
second control means, for providing a mechanism that allows modification of at least a portion of said first control means according to data provided to the gateway.

10. A network gateway, according to claim 9, wherein at least one of said first and second control means includes software.

11. A network gateway, according to claim 10, wherein, upon powering up, said software actuates said second control means for a predetermined amount of time.

12. A network gateway, according to claim 11, wherein, in response to receiving a first particular signal, said software modifies at least a portion of said software.

13. A network gateway, according to claim 12, wherein said first particular signal includes a signal from a remote console indicating access thereby.

14. A network gateway, according to claim 9, wherein the information is provided by an Internet tunnel.

15. A network gateway, according to claim 9, wherein the data is provided via a separate communication channel.

16. A network gateway, according to claim 15, wherein the information is provided by a first Internet tunnel and the separate communication channel is one of: a second Internet tunnel, a dial up line, and a hardwired connection.

17. A network gateway, according to claim 9, wherein the data includes at least one of: configuration data and an image of a portion of the software.

18. A network gateway, comprising:
means for providing a first set of data over the Internet; and
means for reconfiguring operation of the gateway according to a second set of data provided to the gateway through the Internet.

19. A network gateway, according to claim 18, wherein said means for reconfiguring operation of the gateway includes software.

20. A network gateway, according to claim 18, wherein the first set of data is provided by an Internet tunnel.

21. A network gateway, according to claim 18, wherein said second set of data includes at least one of: configuration data and an image of a portion of the software.

22. A data storage medium containing software for operating a network gateway, said software comprising:
means for causing the gateway to provide a first set of data over the Internet; and
means for reconfiguring the gateway according to a second set of data provided thereto in response to the gateway being at least partially non-operational.

23. A data storage medium, according to claim 22, wherein said means for reconfiguring the gateway provides said second set of data thereto via a separate communication channel.

24. A data storage medium, according to claim 23, wherein said first set of data is provided by a first Internet tunnel and wherein said separate communication channel is one of: a second Internet tunnel, a dial up line, and a hardwired connection.

25. A data storage medium, according to claim 22, wherein said second set of data includes at least one of: configuration data and an image of a portion of the software.

26. A data storage medium containing software for operating a network gateway, said software comprising:
first means for causing the gateway to provide data over the Internet; and
second means for modifying said first means according to data provided to the gateway.

27. A data storage medium, according to claim 26, wherein said second means provides said data via a second communication channel.

28. A data storage medium, according to claim 27, wherein the data is provided by a first Internet tunnel and the second communication channel is one of: a second Internet tunnel, a dial up line, and a hardwired connection.

29. A data storage medium, according to claim 26, wherein said data includes at least one of: configuration data and an image of a portion of the software.

30. A method of operating a network gateway, comprising:
providing a first set of data over the Internet while the gateway is in a first mode; and
reconfiguring the gateway in response to a second set of data received by the gateway while the gateway is in a second mode that is different from the first mode.

31. A method, according to claim 30, further comprising:
upon being powered up, the gateway entering the second mode.

32. A method, according to claim 30, wherein, in response to receiving a first particular signal, the gateway remains in the second mode.

33. A method, according to claim 32, wherein the first particular signal includes a signal from a remote console indicating access thereby.

34. A method, according to claim 30, wherein the first set of data is provided by an Internet tunnel.

35. A method, according to claim 30, wherein the second set of data is provided via a separate communication channel.

36. A method, according to claim 35, wherein the first set of data is provided by a first Internet tunnel and the separate communication channel is one of: a second Internet tunnel, a dial up line, and a hardwired connection.

37. A method, according to claim 30, wherein the second set of data includes at least one of: configuration data and an image of a portion of the software.

38. A method of repairing a network gateway, comprising:
switching the gateway into a reconfiguration mode;
accepting data via at least one remote communication channel while the gateway is in the reconfiguration mode; and
reconfiguring the gateway according to the received data.

39. A method, according to claim 38, wherein reconfiguring includes modifying at least one of: software of the gateway and reconfiguration data of the gateway.

40. A method, according to claim 38, wherein the at least one remote communication channel is an Internet tunnel.

41. A method for operating a network gateway, comprising:
causing the gateway to provide data over the Internet; and
reconfiguring the gateway according to remote data provided to the gateway in response to the gateway being at least partially non-operational.

42. A method, according to claim 41, wherein the data is provided by an Internet tunnel.

43. A method for operating a network gateway, comprising:
running software to cause the gateway to provide remote data; and
modifying the software according to data provided to the gateway.

44. A method, according to claim 43, wherein the data is provided by the gateway via an Internet tunnel.
